(19) United States
(12) Patent Application Publication
(10) Pub. No.: US 2023/0061971 A1
(43) Pub. Date: Mar. 2, 2023

(54) MACHINE LEARNING MODEL COMPRESSION

(71) Applicant: International Business Machines Corporation, Armonk, NY (US)

(72) Inventors: Song BO, XI'AN (CN); Dong Hai YU, Xi'AN (CN); Jun WANG, XI'AN (CN)

(21) Appl. No.: 17/411,217

(22) Filed: Aug. 25, 2021

(51) Int. Cl. G06N 20/20; G06K 9/62

(52) U.S. Cl. CPC G06N 20/20; G06K 9/6219; G06K 9/6227; G06K 9/6262

(57) ABSTRACT

A method includes determining a plurality of performance metrics for a plurality of sub-models forming a first machine learning model and clustering the plurality of sub-models based on the plurality of performance metrics to produce a plurality of clusters of sub-models. The method also includes removing, from the first machine learning model, sub-models assigned to a first cluster of the plurality of clusters to produce a second machine learning model formed by the sub-models remaining in the first machine learning model and in response to determining that a performance of the second machine learning model is below a performance threshold, adding a subset of the removed sub-models to the second machine learning model to produce a third machine learning model. The method further includes, in response to determining that a performance of the third machine learning model meets the performance threshold, selecting the third machine learning model to be applied.

### BACKGROUND

The present invention relates to machine learning, and more specifically, to compressing machine learning models.

### SUMMARY

According to an embodiment, a method includes determining a plurality of performance metrics for a plurality of sub-models forming a first machine learning model and clustering the plurality of sub-models based on the plurality of performance metrics to produce a plurality of clusters of sub-models. The method also includes removing, from the first machine learning model, sub-models assigned to a first cluster of the plurality of clusters to produce a second machine learning model formed by the sub-models remaining in the first machine learning model and in response to determining that a performance of the second machine learning model is below a performance threshold, adding a subset of the removed sub-models to the second machine learning model to produce a third machine learning model. The method further includes, in response to determining that a performance of the third machine learning model meets the performance threshold, selecting the third machine learning model to be applied instead of the first machine learning model. Other embodiments include an apparatus for performing this method.

According to another embodiment, a method includes clustering a plurality of sub-models forming a first machine learning model based on at least one of sizes of the plurality of sub-models or performances of the plurality of sub-models to produce a plurality of clusters of sub-models and in response to determining that a size of the first machine learning model exceeds a size threshold, removing, from the first machine learning model, sub-models assigned to a first cluster of the plurality of clusters to produce a second machine learning model formed by the sub-models remaining in the first machine learning model. The method also includes, in response to determining that a performance of the second machine learning model is below a performance threshold, adding a subset of the removed sub-models to the second machine learning model to produce a third machine learning model and in response to determining that a performance of the third machine learning model meets the performance threshold, selecting the third machine learning model to be applied instead of the first machine learning model. Other embodiments include an apparatus for performing this method.

### BRIEF DESCRIPTION OF THE SEVERAL VIEWS OF THE DRAWINGS

FIG. 1A illustrates an example system.

FIG. 1B illustrates an example operation of a computing system in the system of FIG. 1A.

FIG. 1C illustrates an example operation of a computing system in the system of FIG. 1A.

FIG. 2 is a flowchart of an example method performed in the system of FIG. 1A.

FIG. 3 is a flowchart of an example method performed in the system of FIG. 1A.

### DETAILED DESCRIPTION

Machine learning systems use machine learning models to make predictions or decisions based on input datasets. To improve the performance of the machine learning systems (e.g., by improving the accuracy of the predictions), designers of the machine learning systems have expanded the machine learning models to account for larger numbers of distinctions in the datasets and larger numbers of conditions. As a result, the machine learning models have grown in size and complexity, which increases the amount of storage space needed to store the machine learning models and the amount of time and processing resources needed to apply the machine learning models to the datasets.

This disclosure describes a computing system that compresses a machine learning model while attempting to maintain the performance of the machine learning model. The computing system may first perform a lossless compression to reduce the size of the machine learning model without degrading the performance of the machine learning model. If the size of the machine learning model is still too large, the computing system may perform a lossy compression to further reduce the size of the machine learning model while attempting to minimize the impact on performance. During the lossy compression, the computing system removes from the machine learning model a set of sub-models that form part of the machine learning model. If the performance of the machine learning model does not meet a performance threshold, the computing system adds some of the removed sub-models back into the machine learning model. This process continues until the performance of the machine learning model meets the performance threshold. As a result, the computing system reduces the size of the machine learning model while minimizing or limiting the impact on performance, in certain embodiments. In some embodiments, the reduced size of the machine learning model results in the machine learning model occupying less space in storage and consuming less processing resources when applied.

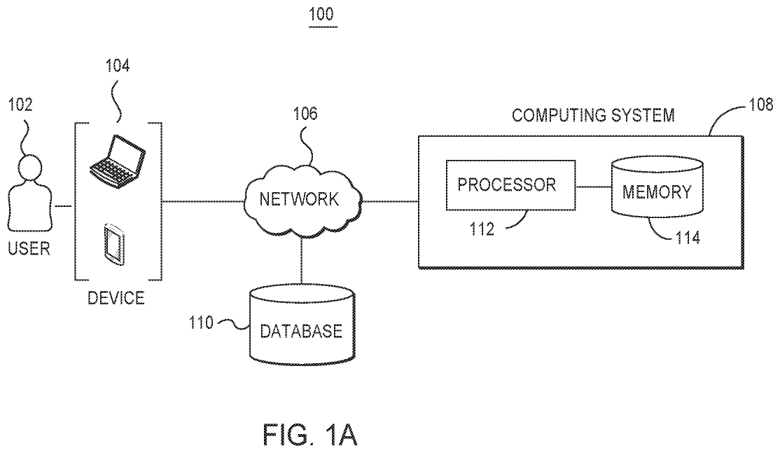

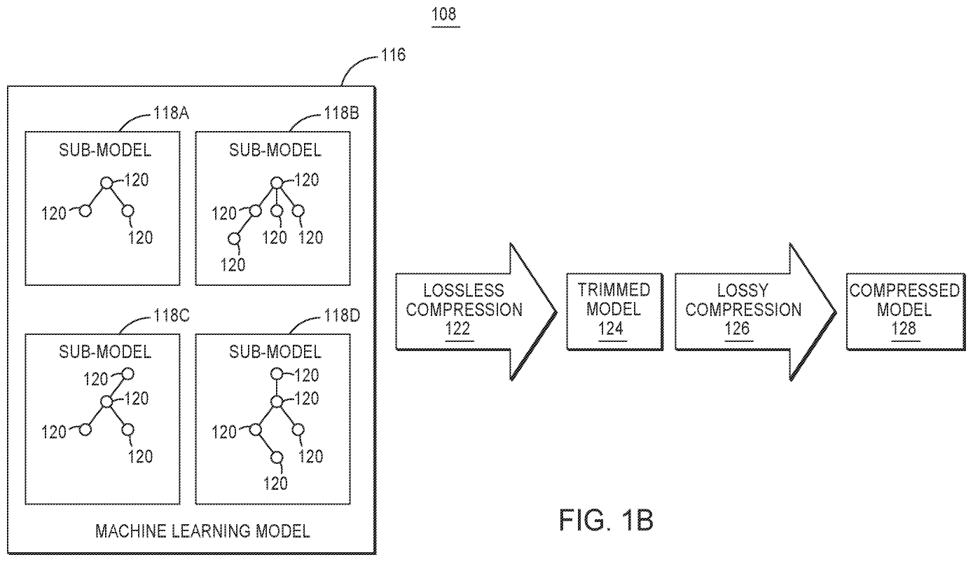

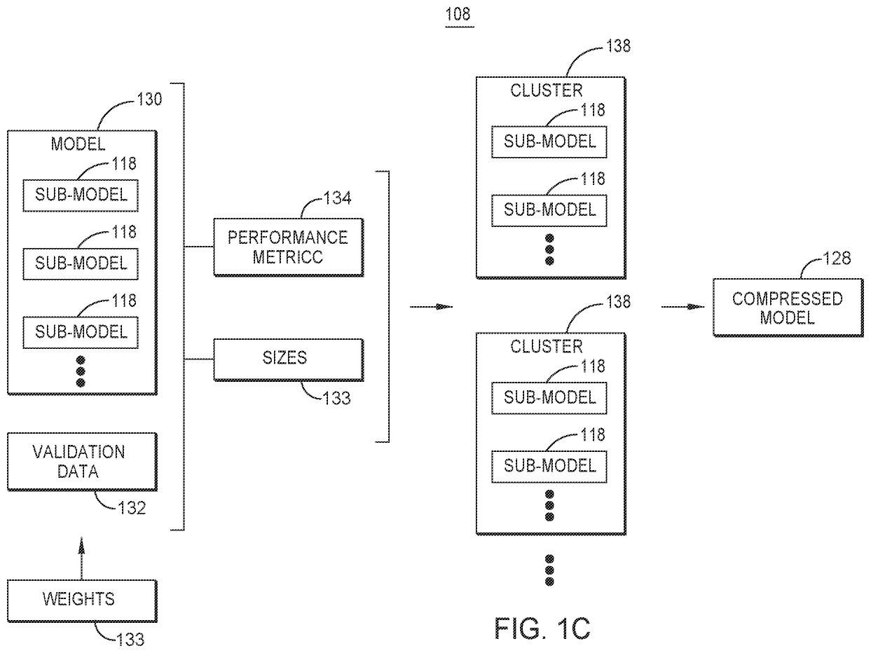

FIG. 1A illustrates an example system 100. As seen in FIG. 1A, the system 100 includes one or more devices 104, a network 106, a computing system 108, and a database 110. The system 100 may be a machine learning system, and the computing system 108 may compress machine learning models and apply the machine learning models to datasets to make predictions or decisions. In particular embodiments, the computing system 108 reduces the size of the machine learning models while minimizing or limiting the impact on the performance of the machine learning models.

The user 102 uses a device 104 to communicate with other components of the system 100 (e.g., the computing system 108). The device 104 may communicate instructions to the computing system 108. For example, the device 104 may instruct the computing system 108 to compress or apply a particular machine learning model. In response, the computing system 108 compresses or applies the machine learning model. The computing system 108 may also return the results of compressing or applying the machine learning model to the device 104. The device 104 may present these results to the user 102 (e.g., through a display).

The device 104 is any suitable device for communicating with components of the system 100 over the network 106. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user 102. The device 104 may include a hardware processor, memory, or circuitry configured to perform any of the functions or actions of the device 104 described herein. For example, a software application designed using software code may be stored in the memory and executed by the processor to perform the functions of the device 104.

The network 106 is any suitable network operable to facilitate communication between the components of the system 100. The network 106 may include any interconnecting system capable of transmitting audio, video, signals, data, messages, or any combination of the preceding. The network 106 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The computing system 108 compresses machine learning models and applies machine learning models to input datasets. The compression process may involve a lossless compression and a lossy compression. In certain embodiments, the computing system 108 performs the lossless and lossy compression processes to reduce the size of a machine learning model while minimizing or limiting the impact on the performance of the machine learning model. As seen in FIG. 1A, the computing system 108 includes a processor 112 and a memory 114, which perform the functions or actions of the computing system 108 described herein.

The processor 112 is any electronic circuitry, including, but not limited to one or a combination of microprocessors, microcontrollers, application specific integrated circuits (ASIC), application specific instruction set processor (ASIP), and/or state machines, that communicatively couples to memory 114 and controls the operation of the computing system 108. The processor 112 may be 8-bit, 16-bit, 32-bit, 64-bit or of any other suitable architecture. The processor 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 112 may include other hardware that operates software to control and process information. The processor 112 executes software stored on the memory 114 to perform any of the functions described herein. The processor 112 controls the operation and administration of the computing system 108 by processing information (e.g., information received from the devices 104, network 106, and memory 114). The processor 112 is not limited to a single processing device and may encompass multiple processing devices.

The memory 114 may store, either permanently or temporarily, data, operational software, or other information for the processor 112. The memory 114 may include any one or a combination of volatile or non-volatile local or remote devices suitable for storing information. For example, the memory 114 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 114, a disk, a CD, or a flash drive. In particular embodiments, the software may include an application executable by the processor 112 to perform one or more of the functions described herein.

The database 110 stores machine learning models in the system 100. In certain embodiments, the system 100 does not include the database 110 and the machine learning models are stored in the device 104 or the computing system 108. Adding the database 110 to the system 100 increases the storage capacity of the system 100. If the machine learning models are stored in the database 110, the device 104 and/or the computing system 108 may retrieve the machine learning models from the database 110. After the device 104 or the computing system 108 have compressed or used the machine learning models, the device 104 or the computing system 108 may store the machine learning models back into the database 110.

FIG. 1B illustrates an example operation of a computing system 108 in the system 100 of FIG. 1A. As seen in FIG. 1B, the computing system 108 compresses a machine learning model 116 to reduce the size of the machine learning model 116. The computing system 108 performs a lossless compression and a lossy compression on the machine learning model 116, which reduces the size of the machine learning model 116 while minimizing or limiting the impact on the performance of the machine learning model 116.

The machine learning model 116 may be any suitable type of machine learning model that may include any suitable structure. In the example of FIG. 1B, the machine learning model 116 is an ensemble tree model that includes multiple sub-models 118. Each sub-model 118 is a tree formed with one or more nodes 120. As seen in FIG. 1B, the machine learning model 116 includes sub-models 118A, 118B, 118C and 118D. The machine learning model 116 may include additional sub-models 118 that are not illustrated. Additionally, each sub-model 118A, 118B, 118C or 188D includes a tree formed using one or more nodes 120. The trees in each sub-model 118 may be different. The computing system 108 applies the machine learning model 116 to input data to make predictions or decisions. For example, each sub-model 118 may be a decision tree formed with one or more connected nodes. The computing system 108 may apply each decision tree to input data to make a decision or prediction based on that data. The computing system 108 may then use the decision or prediction from one tree as part of the input into another tree to make further decision or predictions. In this manner, the computing system 108 can use multiple trees in parallel or in sequence to make one or more decisions or predictions.

The computing system 108 performs a lossless compression 122 on the machine learning model 116 to produce a trimmed model 124. During the lossless compression 122, the computing system 108 analyzes the sub-models 118 of the machine learning model 116 to identify nodes 120 that can be removed from their respective sub-models 118 without impacting the performance of the machine learning model 116. For example, the computing system 108 may identify nodes 120 in a sub-model 118 that are duplicates of other nodes 120 in the sub-model 118. As another example, the computing system 108 may identify nodes 120 that are unreachable within a sub-model 118. An unreachable node 120 may be a node 120 that will never be used or reached because of the particular dataset being evaluated or the logic within the sub-model 118. For example, a node 120 that is only reached if a variable is a particular value is unreachable if the variable will never be that value (e.g., if a node 120 is only reached if the date is April 31). The computing system 108 removes the identified nodes 120 (e.g., the duplicate nodes 120 or the unreachable nodes 120) from the sub-models 118 of the machine learning model 116 to produce the trimmed model 124. By removing these nodes 120, the size of the machine learning model 116 is reduced. Additionally, removing the identified nodes 120 from the sub-models 118 may not degrade the performance of the machine learning model 116. For example, duplicate nodes 120 may be redundant and may be removed without impacting the performance of the machine learning model 116. As another example, unreachable nodes 120 may go unused, and thus, removing the unreachable nodes 120 from the machine learning model 116 does not degrade the performance of the machine learning model 116.

The computing system 108 may perform a lossy compression 126 on the trimmed model 124 to further reduce the size of the trimmed model 124. In certain embodiments, the computing system 108 performs the lossy compression 126 in response to determining that the size of the trimmed model 124 is still too large. For example, the computing system 108 may compare the size of the trimmed model 124 to a size threshold. If the size of the trimmed model 124 exceeds the size threshold, then the computing system 108 performs the lossy compression 126 on the trimmed model 124. The computing system 108 performs the lossy compression 126 on the trimmed model 124 to produce a compressed model 128.

During the lossy compression 126, the computing system 108 determines the performance and/or size of the sub-models 118 within the machine learning model 116. The computing system 108 then clusters the sub-models 118 based on their performances and/or sizes. The computing system 108 then removes, from the trimmed model 124, the sub-models 118 within a cluster. For example, the cluster may be a cluster of sub-models 118 that have the worst performance out of the sub-models 118 in the trimmed model 124. After removing the sub-models 118 from the trimmed model 124, the computing system 108 evaluates the performance of the trimmed model 124. If the performance of the trimmed model 124 has degraded to an unacceptable level, then the computing system 108 adds some of the removed sub-models 118 back into the trimmed model 124. The computing system 108 then re-evaluates the performance of the trimmed model 124. This process repeats until the performance of the trimmed model 124 returns to an acceptable level. When the performance of the trimmed model 124 is acceptable, the computing system 108 considers the lossy compression 126 complete and outputs the resulting model as the compressed model 128. The computing system 108 then selects or applies the compressed model 128 to an input dataset to make predictions or decisions. In this manner, the computing system 108 reduces the size of the machine learning model 116 while minimizing or limiting the impact on the performance of the machine learning model 116, in particular embodiments.

FIG. 1C illustrates an example operation of a computing system 108 in the system 100 of FIG. 1A. Generally, FIG. 1C shows the computing system 108 performing a lossy compression 126. As discussed above, during the lossy compression 126, the computing system 108 removes sub-models 118 from a model 130 and then adds the sub-models 118 back into the model 130 as needed to bring the performance of the model 130 to an acceptable level. As a result, the computing system 108 reduces the size of the model 130 while maintaining the performance of the model 130 at an acceptable level, in particular embodiments.

As seen in FIG. 1C, the computing system 108 operates on a model 130 that includes one or more sub-models 118. The model 130 may be the machine learning model 116 shown in FIG. 1B if the computing system 108 did not perform the lossless compression 122. The model 130 may be the trimmed model 124 shown in FIG. 1B if the computing system 108 did perform the lossless compression 122.

The computing system 108 begins by determining performance metrics 134 for the sub-models 118 in the model 130 by applying the sub-models 118 in the model 130 to validation data 132. The validation data 132 may include input data along with indications of the correct predictions or decisions corresponding to the input data. The computing system 108 applies the sub-models 118 to the input data to determine the prediction or decision made by the sub-models 118. The computing system 108 then compares the predictions or decisions made by the sub-models 118 to the indications of the correct predictions or decisions in the validation data 132 to evaluate how well the sub-models 118 performed. The performance metrics 134 indicate how well the sub-models 118 performed when applied to the validation data 132. For example, the performance metrics 134 may include an accuracy, a precision, a recall, or a variance for each of the sub-models 118 in the model 130.

In particular embodiments, the computing system 108 applies weights 133 to the performance metrics 134 to produce weighted performance metrics for the sub-models 118. The weights 133 may represent an importance of the sub-models 118 to the model 130. For example, if a sub-model 118 is more important or critical to the model 130, then the weight 133 for that sub-model 118 may be higher than the weights 133 for the other sub-models 118 in the model 130. As a result, the performance metric 134 for the more important or critical sub-model 118 may be weighted more heavily than the other performance metrics 134. In certain embodiments, weighting the performance metrics 134 results in certain sub-models 118 being more likely to be removed from the model 130 during the lossy compression 136. For example, sub-models 118 that are less important or critical to the model 130 may be more likely to be removed during loss compression 126.

In certain embodiments the computing system 108 determines the sizes 136 of the sub-models 118 in the model 130. The sizes 136 may indicate the number of nodes 120 in each sub-model 118. The more nodes 120 that a sub-model 118 has, the larger the size 130 for the sub-model 118.

The computing system 108 clusters the sub-models 118 in the model 130 based on the performance metrics 134 (or the weighted performance metrics) and/or the sizes 136 to produce clusters 138 of sub-models 118. The clusters 138 include sub-models 118 in the model 130 with similar performance metrics 134 (or weighted performance metrics) and/or similar sizes 136. The computing system 108 may generate any suitable number of clusters 138 of sub-models 118. Each cluster 138 may include any suitable number of sub-models 118.

The computing system 108 selects a cluster 138 for removal. In certain embodiments, the selected cluster 138 may include the sub-models 118 with the lowest performance metrics 134 (or weighted performance metrics). The computing system 108 then removes the sub-models 118 within the selected cluster 138 from the model 130. The computing system 108 then evaluates the performance of the model 130 by applying the model 130 to the validation data 132. If the performance of the model 130 is at an acceptable level, the computing system 108 outputs the model 130 as the compressed model 128. If the performance of the model 130 is not at an acceptable level, the computing system 108 adds some of the removed sub-models 118 back into the model 130. This process continues until the performance of the model 130 reaches an acceptable level. Then the computing system 108 outputs the model 130 as the compressed model 128. In this manner, the computing system 108 reduces the size of the model 130 while maintaining the performance of the model 130 at an acceptable level.

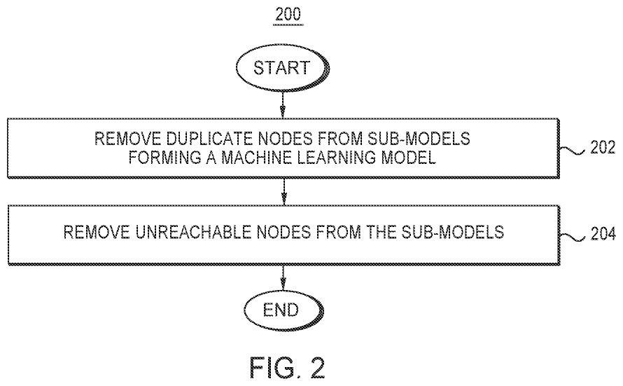

FIG. 2 is a flowchart of example method 200 performed in the system 100 of FIG. 1A. In particular embodiments, the computing system 108 performs the method 200. By performing the method 200, the computing system 108 performs a lossless compression 122 that reduces the size of the machine learning model 116 without degrading the performance of the machine learning model 116.

In block 202, the computing system 108 removes duplicate nodes 120 from sub-models 118 forming the machine learning model 116. The duplicate nodes 120 are redundant and may be removed from the machine learning model 116 without degrading the performance of the machine learning model 116. In block 204, the computing system 108 removes unreachable nodes 120 from the sub-models 118 of the machine learning model 116. The unreachable nodes 120 may be nodes 120 that are unused when applying the sub-models 118 because of the particular input datasets or because of the logic within the sub-models 118. Because the unreachable nodes 120 are unused, they may be removed from the sub-models 118 of the machine learning model 116 without degrading the performance of the machine learning model 116.

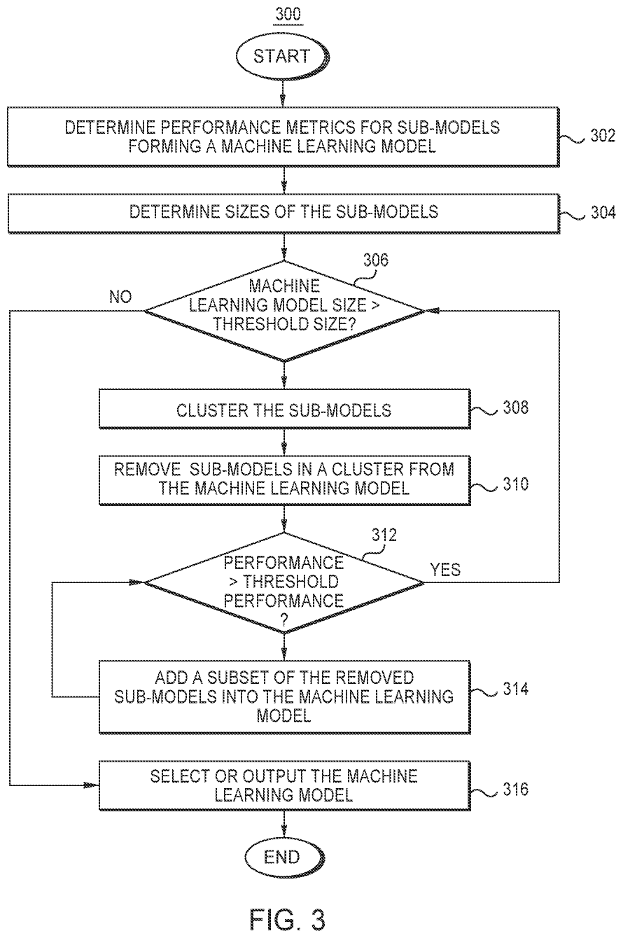

FIG. 3 is a flowchart of an example method 300 performed in the system 100 of FIG. 1A. In particular embodiments, the computing system 108 performs the method 300. By performing the method 300, the computing system 108 performs a lossy compression 126 that reduces the size of a model 130 while maintaining the performance of the model 130 at an acceptable level. The model 130 may be a trimmed model 124 generated by the computing system 108 by performing the lossless compression 122 as described in the method 200 of FIG. 2.

The computing system 108 begins by determining performance metrics 134 for the sub-models 118 that form a model 130 in block 302. The computing system 108 may apply the sub-models 118 of the model 130 to validation data 132 to determine the performance metrics 134. For example, the validation data 132 may include input data and corresponding, correct predictions or decisions. The computing system 108 applies the sub-models 118 to the input data to determine the predictions or decisions made by the sub-models 118. The computing system 108 then compares the predictions or decisions made by the sub-models 118 to the correct predictions or decisions indicated in the validation data 132 to determine the performance of the sub-models 118. The performance of the sub-models 118 is then represented by the performance metrics 134. For example, the performance metrics 134 may include an accuracy, a precision, a recall, or a variance of the sub-models 118.

In some embodiments, the computing system 108 weights the performance metrics 134 using weights 133 for the sub-models 118. The weights 133 represent an importance of the corresponding sub-models 118. For example, a sub-model 118 that is more important or critical to the performance of the model 130 may be assigned a weight 133 that is higher than the weights 133 of the other sub-models 118. The computing system 108 applies the weights 133 to the corresponding performance metrics 134 to generate weighted performance metrics. In this manner, the performance metrics 134 for more important or critical sub-models 118 are weighted more heavily during the lossy compression 126, which may make it less likely that the more important or critical sub-models 118 are removed during the loss compression 126.

In block 304, the computing system 108 determines the sizes 136 of the sub-models 118. In some embodiments, the sizes 136 correspond to the number of nodes 120 in the sub-models 118. The more nodes 120 that are in a sub-model 118, the larger the size 136 of the sub-model 118.

In block 306, the computing system 18 determines whether the size of the model 130 exceeds a threshold size. If the size of the model 130 does not exceed the threshold size, then the computing system 108 determines that the model 130 has an acceptable size, and selects or outputs the model 130 as the compressed model 128. The computing system 108 then applies the compressed model 128 to make predictions and/or decisions.

If the size of the model 130 exceeds the threshold size, then the computing system 108 determines that the size of the model 130 should be reduced through the lossy compression process 126. In block 308, the computing system 108 clusters the sub-models 118 of the model 130. In some embodiments, the computing system 108 clusters the sub-models 118 based on the performance metrics 134 (or the weighted performance metrics) and/or the size 136. The computing system 108 generates multiple clusters 138 of sub-models 118. The sub-models 118 in a cluster 138 may have similar performance metrics 134 (or weighted performance metrics) and/or sizes 136.

In block 310, the computing system 108 removes sub-models 118 in a cluster 138 from the model 130. In some embodiments, the computing system 108 selects a cluster 138 of sub-models 118 that impact the performance of the model 130 the least. For example, the computing system 108 may select a cluster 138 of sub-models 118 with the lowest performance metrics 134 (or weighted performance metrics) and/or the largest sizes 136. The computing system 108 then removes the sub-models 118 within the selected cluster 138 from the model 130.

In block 312, the computing system 108 determines whether the performance of the model 130 exceeds a threshold performance after removing the sub-models 118 from the model 130. The computing system 108 may determine the performance of the model 130 by applying the remaining sub-models 118 in the model 130 to the validation data 132. The computing system 108 then compares the performance of the model 130 against a threshold performance. If the performance of the model 130 does not meet or exceed the threshold performance, the computing system 108 determines that the performance of the model 130 is not at an acceptable level. In response, the computing system 108 adds a subset of the removed sub-models 118 back into the model 130 in block 314. In some embodiments, the computing system 108 adds half of the removed sub-models 118 back into the model 130. The computing system 108 then returns to block 312 to evaluate the performance of the model 130 against the threshold performance. This process of adding a subset of the removed sub-models 118 back into the model 130 continues until the performance of the model 130 reaches an acceptable level.

When the computing system 108 determines that the performance of the model 130 has reached an acceptable level, the computing system 108 returns to block 306 to determine if the size of the model 130 is at an acceptable level by comparing the size of the model 130 against the threshold size. If the size of the model 130 is still too large, the computing system 108 may again perform the lossy compression 126 by removing another cluster 138 of sub-models 118 from the model 130. If the size of the model 130 is below the threshold size, then the computing system 108 selects or outputs the model 130 as the compressed model 128. The computing system 108 may then apply the compressed model 128 to make predictions or decisions.

In some embodiments, the computing system 108 performs error checking during the lossy compression 126. For example, if the computing system 108 generates or selects an empty cluster 138, the computing system 108 may throw an error indicating that the cluster 138 is empty and that there are no sub-models 118 to be removed from or added to the model 130. A user 102 may then review the error to troubleshoot the computing system 108. For example, the user 102 may adjust the validation data 132, the threshold size, or the threshold performance and then restart the lossy compression 126.

In summary, a computing system 108 compresses a machine learning model 116 while attempting to maintain the performance of the machine learning model 116. The computing system 108 may first perform a lossless compression 122 to reduce the size of the machine learning model 116 without degrading the performance of the machine learning model 116. If the size of the machine learning model 116 is still too large, the computing system 108 may perform a lossy compression 126 to further reduce the size of the machine learning model 116 while attempting to minimize the impact on performance. During the lossy compression 126, the computing system 108 removes from the machine learning model 116 a set of sub-models 118 that form part of the machine learning model 116. If the performance of the machine learning model 116 does not meet a performance threshold, the computing system 108 adds some of the removed sub-models 118 back into the machine learning model 116. This process continues until the performance of the machine learning model 116 meets the performance threshold. As a result, the computing system 108 reduces the size of the machine learning model 116 while minimizing or limiting the impact on performance, in certain embodiments.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge computing systems. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or computing system. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., computing systems, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access the computing system 108 or related data available in the cloud. For example, the computing system 108 could execute on a computing system in the cloud. In such a case, the computing system 108 could compress machine learning models 116 and store the machine learning models 116 at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
determining a plurality of performance metrics for a plurality of sub-models forming a first machine learning model;
clustering the plurality of sub-models based on the plurality of performance metrics to produce a plurality of clusters of sub-models;
removing, from the first machine learning model, sub-models assigned to a first cluster of the plurality of clusters to produce a second machine learning model formed by the sub-models remaining in the first machine learning model;
in response to determining that a performance of the second machine learning model is below a performance threshold, adding a subset of the removed sub-models to the second machine learning model to produce a third machine learning model; and
in response to determining that a performance of the third machine learning model meets the performance threshold, selecting the third machine learning model to be applied instead of the first machine learning model.

2. The method of claim 1, further comprising removing a duplicate node from a sub-model of the plurality of sub-models before determining the plurality of performance metrics.

3. The method of claim 1, further comprising determining a plurality of sizes of the plurality of sub-models, wherein clustering the plurality of sub-models is further based on the plurality of sizes.

4. The method of claim 1, wherein determining the plurality of performance metrics comprises applying the plurality of sub-models to validation data to determine a performance of each sub-model of the plurality of sub-models and wherein the performance of the second machine learning model and the performance of the third machine learning model are determined based on the validation data.

5. The method of claim 4, wherein determining the plurality of performance metrics further comprises weighting the performances of the sub-models of the plurality of sub-models with a plurality of weights for the plurality of sub-models to produce the plurality of performance metrics.

6. The method of claim 1, further comprising throwing an error in response to determining that a second cluster of sub-models of the plurality of clusters of sub-models is empty.

7. The method of claim 1, wherein the subset of the removed sub-models is half of the removed sub-models.

8. The method of claim 1, wherein the plurality of performance metrics comprises at least one of an accuracy, a precision, a recall, or a variance of the plurality of sub-models.

9. The method of claim 1, further comprising removing an unreachable node from a sub-model of the plurality of sub-models before determining the plurality of performance metrics.

10. An apparatus comprising:
a memory; and
a hardware processor communicatively coupled to the memory, the hardware processor configured to:
determine a plurality of performance metrics for a plurality of sub-models forming a first machine learning model;
cluster the plurality of sub-models based on the plurality of performance metrics to produce a plurality of clusters of sub-models;
remove, from the first machine learning model, sub-models assigned to a first cluster of the plurality of clusters to produce a second machine learning model formed by the sub-models remaining in the first machine learning model;
in response to determining that a performance of the second machine learning model is below a performance threshold, add a subset of the removed sub-models to the second machine learning model to produce a third machine learning model; and
in response to determining that a performance of the third machine learning model meets the performance threshold, select the third machine learning model to be applied instead of the first machine learning model.

11. The apparatus of claim 10, the hardware processor further configured to remove a duplicate node from a sub-model of the plurality of sub-models before determining the plurality of performance metrics.

12. The apparatus of claim 10, the hardware processor further configured to determine a plurality of sizes of the plurality of sub-models, wherein clustering the plurality of sub-models is further based on the plurality of sizes.

13. The apparatus of claim 10, wherein determining the plurality of performance metrics comprises applying the plurality of sub-models to validation data to determine a performance of each sub-model of the plurality of sub-models and wherein the performance of the second machine learning model and the performance of the third machine learning model are determined based on the validation data.

14. The apparatus of claim 13, wherein determining the plurality of performance metrics further comprises weighting the performances of the sub-models of the plurality of sub-models with a plurality of weights for the plurality of sub-models to produce the plurality of performance metrics.

15. The apparatus of claim 10, the hardware processor further configured to throw an error in response to determining that a second cluster of sub-models of the plurality of clusters of sub-models is empty.

16. The apparatus of claim 10, wherein the subset of the removed sub-models is half of the removed sub-models.

17. The apparatus of claim 10, wherein the plurality of performance metrics comprises at least one of an accuracy, a precision, a recall, or a variance of the plurality of sub-models.

18. The apparatus of claim 10, the hardware processor further configured to remove an unreachable node from a sub-model of the plurality of sub-models before determining the plurality of performance metrics.

19. A method comprising:
clustering a plurality of sub-models forming a first machine learning model based on at least one of sizes of the plurality of sub-models or performances of the plurality of sub-models to produce a plurality of clusters of sub-models;
in response to determining that a size of the first machine learning model exceeds a size threshold, removing, from the first machine learning model, sub-models assigned to a first cluster of the plurality of clusters to produce a second machine learning model formed by the sub-models remaining in the first machine learning model;
in response to determining that a performance of the second machine learning model is below a performance threshold, adding a subset of the removed sub-models to the second machine learning model to produce a third machine learning model; and
in response to determining that a performance of the third machine learning model meets the performance threshold, selecting the third machine learning model to be applied instead of the first machine learning model.

20. The method of claim 19, further comprising removing a duplicate node from a sub-model of the plurality of sub-models before determining the plurality of performance metrics.
